(19) United States
(12) Patent Application Publication
(10) Pub. No.: US 2004/0088175 A1
(43) Pub. Date: May 6, 2004

(54) Digital-rights management

(76) Inventors: Thomas Messerges, Schaumburg, IL (US); Ezzat A. Dabbish, Cary, IL (US)

Correspondence Address: MOTOROLA, INC., 1303 EAST ALGONQUIN ROAD, IL01/3RD, SCHAUMBURG, IL, 60196

(21) Appl. No.: 10/286,697

(22) Filed: Nov. 1, 2002

(51) Int. Cl. G06F 17/60; H04L 9/00

(52) U.S. Cl. 705/1; 713/200

(57) ABSTRACT

A method and apparatus for digital-rights management is provided herein. Various forms of authorization are allowed, with each form of authorization being dependent upon an action taken on the digital content. In particular, when server-based authorization is unavailable, less-risky operations are allowed by performing an internal authorization scheme. Thus, higher security offered by a server-based DRM is required for risky actions, yet non-risky actions on the digital content may still be taken when the server is unavailable.

### FIELD OF THE INVENTION

The present invention relates generally to digital-rights management and in particular, to a method and apparatus for server, and non-server based digital-rights management.

### BACKGROUND OF THE INVENTION

Digital-rights management (DRM) is commonly used to control the copying, distribution, and execution of digital content such as music, games, video, pictures, books, maps, software, . . . , etc. As is known, certain DRM operations on digital content are inherently more powerful and, therefore, potentially more risky to allow than others. For example, “counted-play”, “pay-per-view”, “loaning”, “copying”, or “transferring” operations are more powerful than other simpler operations, such as a “play” operation. Additionally, some of these operations require the DRM system to maintain state information. For example, the loan operation requires the DRM system to remember the state of a loan. Just as in the case of loaning a physical copy of content, when digital content is loaned to another entity, the content may be unavailable to the original owner or device for the period of the loan. This state information needs to be securely maintained in order to ensure proper rights enforcement. Similarly, the “copy” or “transfer” operation may elicit a need to track the number of copies and the “counted-play” operation may elicit a need to track the number of plays.

In order to account for these more powerful operations, DRM systems have established different schemes for enforcing DRM rules and maintaining the state information. For example, as described in U.S. Pat. No. 6,236,971, each usage right may specify a digital ticket which must be present before the right is exercised. The ticket of '971 travels with the content and is “punched” by a ticket agent when an action on the content is exercised. By requiring tickets to be “punched” by a ticket agent, this agent is responsible for maintaining the state information. This agent may reside in the local repository with the content or may be a “special” ticket agent residing on another repository.

It is recognized that the state information may reside locally on the device, or remotely at a server. A server-based DRM system may result in a more secure DRM system. However, in many situations, continuous contact with a trusted server is impractical. For example, a user utilizing a cellular telephone may have only intermittent access to the server as the user roams in and out of cellular coverage. It is recognized that storing the state information locally solves this issue, but could lead to a less secure implementation.

The problem of where to securely maintain the state information becomes even more of an issue in a domain-based DRM system. In a domain-based DRM system, multiple devices can have simultaneous access to the digital content. The state information for more powerful DRM operations, such as loan or copy, cannot be stored locally, since if one device in the domain performs one of these more powerful operations, the other devices in the domain would also need to know about it. Again, a server-based DRM system could provide a central repository for the state information. However, when continuous contact with a trusted server is impractical, such as the case with cellular telephones, the user experience is diminished. For example, when a contact with the server is lost, all actions on the digital content would be prevented. Also, communicating with a central server for all DRM operations can result in costly over-the-air charges for low-bandwidth systems such as in a cellular telephone system.

Thus, a need exists for a method and apparatus that allows for the higher security offered by server-based DRM, and operates with a domain of devices, yet allows for a user to break contact with the server and continue performing some actions on the digital content.

### BRIEF DESCRIPTION OF THE DRAWINGS

FIG. 1 is a block diagram of a communication system utilizing digital-rights management in accordance with the preferred embodiment of the present invention.

FIG. 2 illustrates a digital-rights management license in accordance with the preferred embodiment of the present invention.

FIG. 3 is a block diagram of a communication system utilizing digital-rights management in accordance with an alternate embodiment of the present invention.

FIG. 4 is a block diagram of a communication system utilizing digital-rights management in accordance with a further alternate embodiment of the present invention.

FIG. 5 is a flow chart showing operation of the communication systems of FIG. 1, FIG. 3., and FIG. 4 in accordance with the various embodiments of the present invention.

### DETAILED DESCRIPTION OF THE DRAWINGS

To address the above-mentioned need, a method and apparatus for digital-rights management is provided herein. In accordance with the preferred embodiment of the present invention, various forms of authorization are allowed, with each form of authorization being dependent upon an action taken on the digital content. In particular, when server-based authorization is unavailable, some operations are allowed by performing an internal authorization scheme. Thus, higher security offered by a server-based DRM can be required for risky actions, such as those requiring the maintenance of state information, yet non-risky actions on the digital content may still be taken when the server is unavailable. In all cases, however, the server maintains the required state information.

The present invention encompasses a method comprising the steps of determining an action to be performed on a digital item, performing an external authorization if the action is from a first group of actions, and performing an internal authorization if the action is from a second group of actions.

The present invention additionally encompasses a method for digital-rights management. The method comprises the steps of determining a first action to be performed on digital content and based on the first action, utilizing a first authorization scheme to allow the first action to be performed. The present invention additionally encompasses determining a second action to be performed on the digital content and based on the second action, utilizing a second authorization scheme to allow the second action to be performed, wherein the second authorization scheme differs from the first authorization scheme.

The present invention additionally encompasses a method comprising the steps of determining an action to be performed on a digital item, determining if a token exists to perform the action, and performing an internal authorization if a token exists, otherwise performing an external authorization.

The present invention additionally encompasses a digital-rights management (DRM) license comprising an action and an enabling server that is based on the action.

The present invention additionally encompasses a method comprising the steps of receiving a request from a device to perform an action on a digital item, determining that the device is part of a group, authorizing the action to be performed on the digital item, updating internal state information to reflect that the action has been performed on the digital item, and transmitting a message to all devices within the group instructing the devices to update internal state information to reflect that the action has been performed on the digital item.

Finally, the present invention encompasses an apparatus comprising a digital item, a license to use the digital item, and a digital-rights management (DRM) module, the DRM module determining an action to perform on the digital item and analyzes the license to determine a method for authorizing the digital item when a server is unavailable.

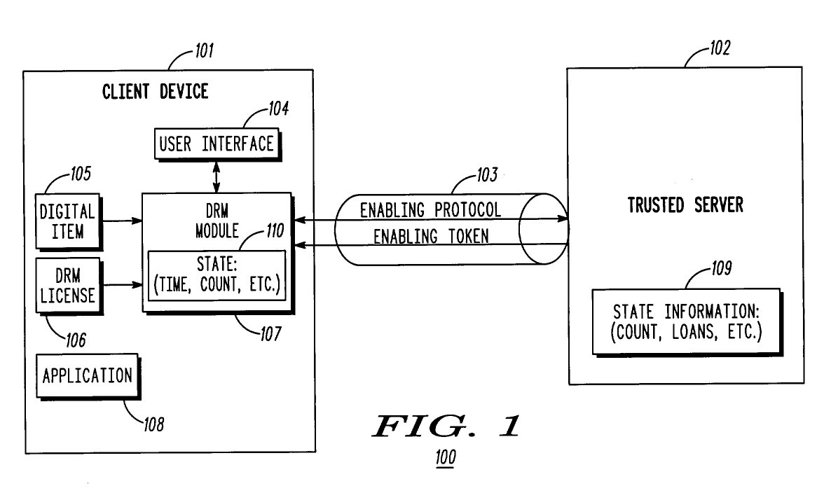

Turning now to the drawings, wherein like numerals designate like components, FIG. 1 is a block diagram of communication system 100 utilizing DRM in accordance with the preferred embodiment of the present invention. As shown, communication system 100 comprises client device 101 and server 102 linked together via interface 103. In the preferred embodiment of the present invention client device 101 preferably comprises a device that intermittently loses contact with server 102 when interface 103 becomes unavailable. Such devices include, for example a cellular telephone that loses connection with server 102 when the over-the-air interface is unavailable. Other devices include, but are not limited to set-top boxes, car radios, networked MP3 players, wireless PDA, . . . , etc. Additionally, server 102 preferably comprises a computer or workstation that provides authorization data to client devices accessing server 102.

Client device 101 additionally comprises user interface 104, digital item 105, license 106, and DRM module 107. In the preferred embodiment of the present invention user interface 104 preferably comprises an alphanumeric keypad and display commonly found on existing cellular telephones. Digital item 105 comprises standard digital content such as, but not limited to digital music, games, video, pictures, books, maps, software, . . . , etc. As is well known in the art, digital item 105 may be stored within client device on any acceptable media that can store data. Such media include, but are not limited to, hard disk media, random access memory RAM, read-only memory (ROM), and the like. Server 102 additionally comprises state information 109, which can include, but is not limited to play counts, loan data, etc.

Continuing, license 106 is preferably a modified DRM license that indicates a particular authorization method based on an action to be taken on digital item 105. License 106 is preferably stored in memory (not shown) such as RAM, ROM, hard disk memory, . . . etc. Finally, DRM module 107 preferably comprises a microprocessor controller such as, but not limited to ARM or M*CORE processor available from a variety of semiconductor manufacturers. DRM module 107 utilizes a modified Rights Expression Language (REL) such as the extensible Rights Mark-up Language (XrML) or the Open Digital Rights Language (ODRL). Module 107 allows the user of digital content to perform an action on that content by analyzing license 106 to determine rules embodied within license 106.

It is contemplated that all elements within communication system 100 are configured in well known manners with processors, memories, instruction sets, and the like, which function in any suitable manner to perform the function set forth herein.

During operation, a user will attempt to perform an action on digital item 105. Such action might include playing the digital content. Other actions include, but are not limited to printing, displaying, transferring, loaning, copying, pay-per-view, one-time-play, . . . , etc. As one of ordinary skill in the art will recognize, a typical action will comprise the execution of application 108. Application 108 preferably comprises processors/instruction sets necessary to perform the action requested. For example, digital item 105 may comprise music encoded in a well-known manner, such as an MPEG Audio Layer 3 (MP3) file, while application 108 comprises a standard MP3 player. A user may want to “play” the music file. Once instructed by the user, and after the DRM license has been checked to determine the user's rights, application 108 (in this case, an MP3 player) performs those tasks necessary to play the digital item.

As discussed above, some actions performed on digital content 105 require the maintenance of state information. Prior-art server-based DRM systems require that a device contact a trusted server whenever any action is performed on digital content or use tickets based schemes (e.g., the '971 patent). Therefore, in a server-based DRM system, a user would be prevented from performing all actions on the digital content while out of server coverage, or a ticket would need to be propagated with the content. In other words, even actions on the digital content that do not require the maintenance of state information would require a ticket or be prevented when the user is out of server coverage.

In order to address this issue, in the preferred embodiment of the present invention license 106 contains an action-specific authorization scheme when server 102 is unavailable. More particularly, for a first group of actions (more risky) on digital item 105, server-based authorization is required, however, for a second group of actions (less risky), a non-server-based authorization may sometimes be permissible. Therefore, in accordance with the preferred embodiment of the present invention, a particular file (digital item 105) will have multiple authorization schemes, each dependent upon the action taken on the file. Therefore, when an action is requested to be performed on digital content 105, DRM module 107 will determine if internal authorization is acceptable. If this is the case, (that is, a server-based authorization is not required), then authorization occurs internally. For example, DRM module 107 may verify the digital signature of license 106 to ensure the integrity and authenticity of the license and prove that the action is allowed.

However, if server-based authorization is required a standard server-based authorization will take place. For example, DRM module 107 will need to establish secure communications with the server and obtain permission for the requested action. In some cases, external, server-based authorization will be preferred, but local authorization will be allowed. In these cases, the local authorization may be permitted for a period of time or be limited to a certain number of times.

As discussed, DRM module 107 will determine if an action will require authorization from server 102 or if authorization can be achieved via a non-server based authorization. This results in an external authorization being performed for a first group of actions (risky) and an internal authorization being performed for a second group of actions (non-risky). Because of this, the preferred embodiment of the present invention allows for the higher security offered by server-based DRM for risky actions that require state information, yet allows for a user to break contact with the server and continue to perform some actions on the digital content.

DRM module 107 utilizes a modified Rights Expression Language (REL) augmented so that individual actions can be constrained to force interaction with a trusted server. An additional constraint (enablingServer) is added to an existing REL. This enablingServer is based on a particular action and provides a pointer (e.g., a Uniform Resource Locater (URL)) to the server that needs to be contacted prior to executing the given right. This server authorizes the given action and provides updated state information to DRM module 107 state database 110. In various embodiments of the present invention the enablingServer constraint also provides for three optional attributes: alwaysRequired, timeAllowedSinceLast, and numberAllowedSinceLast.

The presence of an enablingServer constraint indicates that server-based authorization is preferred and that mere internal authorization may not be allowed. When the enabling server is available, it and the client device execute an enabling protocol, which, if successful, will enable the client device to execute the constrained right. When the server is unavailable, DRM module 107 will examine the attributes of the enablingServer constraint. The alwaysRequired attribute requires that the server must be contacted for authorization and delivery of the current state information. The timeAllowedSinceLast attribute assigns a time value that means that the server must be contacted if the last time the server was contacted is greater than the given amount of time. The numberAllowedSinceLast attribute assigns a count such that the server must be contacted if the number of times this action has been performed since the last time the server was contacted is greater than the given count.

If more than one attribute is present, then all attribute conditions must be satisfied before the action can be performed. If no attribute is given, the default attribute is alwaysRequired. DRM module 107 tracks the count and the time since the last server contact and other state information in its state database 110. If the enablingServer constraint is not present for an action, then that action does not require server authorization. In this case, local authorization is sufficient.

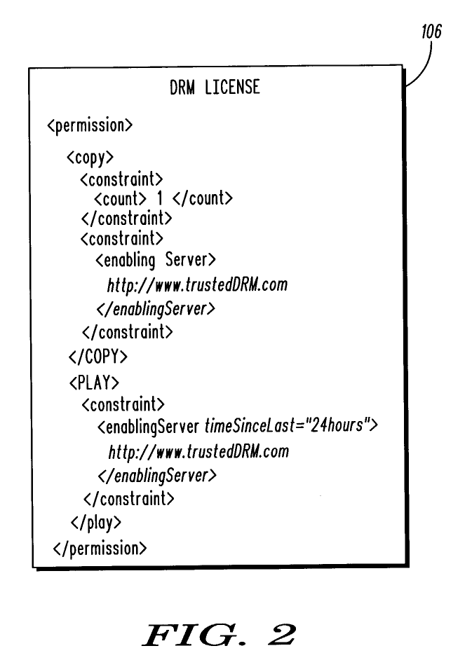

FIG. 2 illustrates a Digital-Rights Management License in accordance with the preferred embodiment of the present invention. In this example, two actions are shown, namely “play” and “copy”. As is evident, an enabling server (enablingServer=www.trustedDRM.com) is identified for both the “copy” and “play” actions. Furthermore, the “copy” right requires contact with an enabling server at all times; however, the “play” right has the timeAllowedSinceLast attribute which indicates that as long as the server was contacted within the last 24 hours, the “play” action can still be performed, even if the server is currently unavailable.

When server 102 is available and client 101 desires to execute an enablingServer-constrained action, it is required to forward DRM license 106 to server 102. Server 102 can then determine whether client 101 should be allowed to execute the enablingServer-constrained action. Server 102 can check its revocation and fraud lists to make sure that client device 101 is legitimate. Server 102 can also record a number of plays (e.g., one-time-play) in its state information database 109 and also send updated state information to the state database 110 in DRM module 107.

Once server 102 decides to allow the client to execute the action, server 102 creates a token that allows the client to execute the desired action. This token may be digitally signed and may also be in the form of another DRM license—for example, a one-time-use license. Upon receiving the enabling token, the client device's DRM module 107 allows the right to be executed and then it deletes the token.

When module 107 does not find an enablingServer constraint in DRM license 106 for the requested action, internal authorization can take place. For internal authorization, module 107 will execute the desired action in a trusted environment (e.g., the digital content will be handled in a secure manner to prevent unauthorized access).

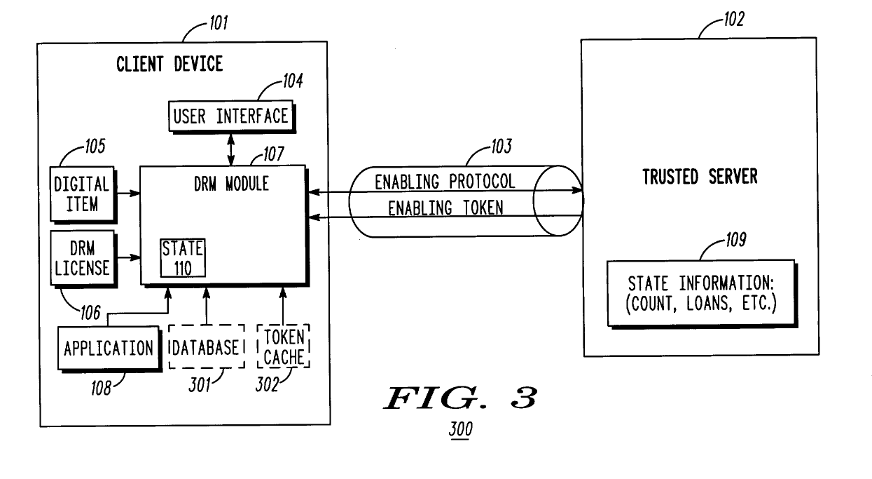

FIG. 3 is a block diagram of communication system 300 utilizing digital-rights management in accordance with various embodiments of the present invention. As is evident, database 301 and token cache 302 have been added to client 101 of FIG. 1. In a first alternate embodiment, license 106 does not include information on whether local authorization is acceptable. This information is obtained within database 301. More particularly, database 301 contains the constraints and possible attributes (e.g., alwaysRequired, timeAllowedSinceLast, and numberAllowedSinceLast) for those actions where internal authorization is allowed. For example, database 301 might contain actions such as “play”, “delete”, . . . , etc. Thus, when an action is requested, DRM module 107 will check to see if this action is in the database 301. If the requested action is not in database 301, an attempt will be made to contact server 102 for authorization. If server 102 is not available, DRM module 107 will not allow the action to be executed. If the requested action is in database 301, then the action requested can be locally authorized, and if so, local authorization takes place. Database 301 could be trivially altered to contain the operations that require server authorization (instead of those that do not require server authorization). In this case, any action requested that is listed in database 301 could not be executed until authorization from server 102 is obtained.

In a second alternate embodiment, DRM module 107 stores tokens received from server 102. These tokens are saved into token cache 302 and can be used at a later time when server 102 is unavailable. Thus when server 102 is unavailable, internal authorization will occur if the action is from a non-risky group, or from a group in which a stored token exists. Thus, prior to performing an action on a digital item, DRM module 107 will determine if a external authorization is necessary or if a token exists to perform the action. If a token exists DRM module 107 executes the user-selected action and deletes the corresponding token from the token cache 302. The use of token cache 302 allows for a user to preload his device with tokens when he anticipates being disconnected from the server. With the use of the token cache 302, tokens for risky operations that require server connectivity can be preloaded when within range of a server and used when the device is not connected to the server, thereby resulting in added flexibility for intermittently connected devices. Tokens can also be set to expire, so that tokens in the token cache 302 are only good for a limited time, which is determined by the server 102.

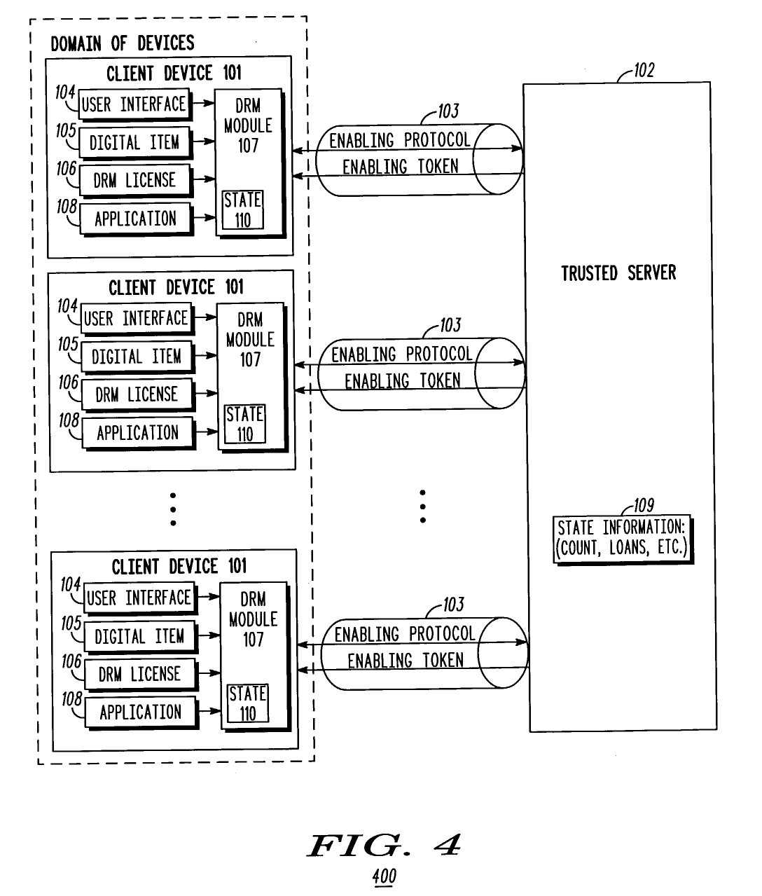

FIG. 4 is a block diagram of communication system 400 utilizing digital-rights management in accordance with further preferred embodiment of the present invention. As is evident, multiple client devices 101 are present in FIG. 4. In the preferred embodiment of the present invention, the client devices may be organized into a domain (or family) of devices 401. Whenever any of the client devices 101 from a family requests an action requiring authorization from an enabling server 102, the client device that requested the action, performs an enabling protocol 103 to obtain a token.

When client devices 101 are part of a family, they share access to copies of a common digital item 105 from FIG. 1. In this case, whenever one of the devices requests an action on this content, the enabling server 102 can record and track that this action was requested. For example, if one of the client devices 101 in a group “copies” the content outside of the domain, then the enabling server can record that this “copy” action was requested. Thus, when another client 101 in the group wishes to perform a “copy” action, the enabling server can check its state database 109 and determine that a “copy” already occurred, thus another “copy” may not be allowed. The enabling server also sends a message to each device in the domain to update their local databases 110 with the fact that the copy occurred. For example, in a cellular telephone system, this update message might be in the form of an SMS message.

Thus, in accordance with the further alternate embodiment, an enabling server will update internal state information 109 whenever a particular action is being performed on a digital item. The updating will reflect that the action has been performed on the digital item. When the user performing the action is part of a larger group of users “sharing” the rights to the content, server 102 will notify all members of the group that the particular action has been taken. In particular, a message will be transmitted to all devices within the group instructing the devices to update internal state information to reflect that the action has been performed on the digital item. The devices within the group will update their state information 110 accordingly.

As with the embodiments described with reference to FIG. 1 and FIG. 3, more powerful DRM actions that require state information, such as “copy”, would require authorization from an enabling server, while other actions, such as “play”, would require only local authorization. Thus, a group of devices can be enabled to share content even though the individual client devices 101 are not always connected to the server 102.

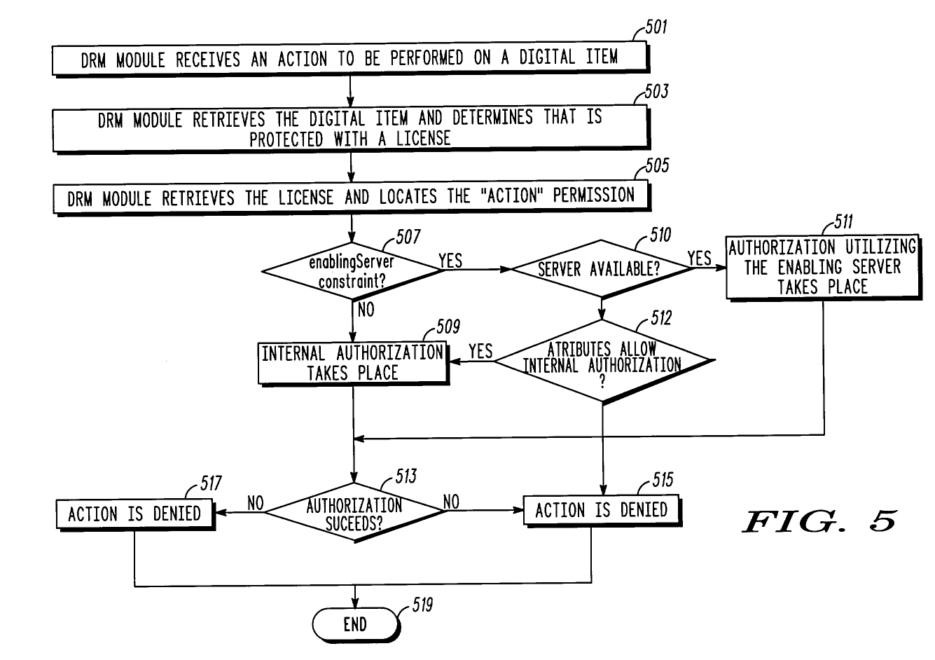

FIG. 5 is a flow chart showing operation of the communication systems of FIG. 1, FIG. 3, and FIG. 4. The logic flow begins at step 501 where DRM module 107 determines an action to be performed on digital item 105. For example, the user of client device 101 operates with user interface 104 to request that digital item 105 be “played”. This request is communicated to DRM module 107. At step 503, DRM module 107 retrieves digital item 105 and determines that it is protected with DRM license 106. At step 505, DRM module 107 retrieves DRM license 106 and locates the action (e.g., the “play” routine). Then, at step 507, the “play” permission is analyzed to see if it contains an enablingServer constraint. In the first embodiment of the present invention, this step entails checking license 106 to determine if an enablingServer is identified within license 106 and in the alternate embodiment of the present invention, database 301 is analyzed to see if the action required is one that requires an enabling server.

If an enabling server is required, step 510 checks for the availability of the server. If the server is available, then authorization with the enabling server occurs at step 511. As discussed above, authorization can be based on actions taken by other devices within a devices “family”. For example, a family of devices may have authorization to “play” the digital content a predetermined number of times. Server 102 can check to see if other devices within the family have previously “played” the content, and based on this information, may or may not allow device 101 to “play” the content.

Continuing, if at step 507 it is determined that an enablingServer constraint is not present, then authorization can be made internally, so at step 509 an internal authorization takes place. The result of the authorizations at steps 511 or 509 is checked at step 513. If authorization succeeds, then the action is allowed at step 517 and the process ends at step 519. Otherwise, the action is denied at step 515 and the process ends at step 519.

Returning to step 510, if at step 510 the server was not available, then the attributes of the enablingServer constraint are checked (e.g., timeAllowedSinceLast) at step 512. If internal authorization is still not allowed at step 512, then the action is denied at 515 and the process ends at step 519. Otherwise, internal authorization is allowed and the process continues from step 509.

Because internal authorization is performed for actions that are inherently less risky, contact with the server can be broken, yet a user may still perform some actions on the digital content. Thus, in accordance with the preferred embodiment of the present invention each digital item has various forms of authorization, each dependent upon an action taken on the content. Thus, DRM module 107 may determining a first action (e.g., “play”) to be performed on digital content and based on the first action, utilize a first authorizing scheme (e.g., internal) to allow the first action to be performed. DRM module 107 may then determine that the user wishes to perform a second action (e.g., “copying”) on the digital content. However, based on the second action module 107 will require utilizing a second authorization scheme (e.g., external) to allow the second action to be performed.

While the invention has been particularly shown and described with reference to a particular embodiment, it will be understood by those skilled in the art that various changes in form and details may be made therein without departing from the spirit and scope of the invention. For example, although the above description was given with respect to having two forms of authorization available, one of ordinary skill in the art may recognize that multiple forms of authorization may be utilized for a single file based on the action taken. For example, a distributor of digital content may wish to have three forms of authorization available for a single digital file. Actions like viewing or playing the file may require the least stringent authorization scheme while actions like copying or distributing may require the most stringent authorization scheme. An intermediate authorization scheme such as performing the action, but logging and uploading the log to a server at a later time might be available for operations such as pay-per-play. It is intended that such changes come within the scope of the following claims.

1. A method comprising the steps of:
determining an action to be performed on a digital item;
performing an external authorization if the action is from a first group of actions; and
performing an internal authorization if the action is from a second group of actions.

2. The method of claim 1 wherein the step of performing external and internal authorization comprises the steps of:
performing the external authorization if the action is from a group of risky actions; and
performing the internal authorization if the action is from a group of non-risky actions.

3. The method of claim 1 wherein the step of performing external and internal authorization comprises the steps of:
performing the external authorization if the action is from a group of risky actions; and
performing the internal authorization if the action is from a group of non-risky actions or from a group of items in which a token exists.

4. The method of claim 1 wherein the step of determining the action comprises the step of determining an action taken from the group consisting of playing, counted-play, pay-per-view, printing, displaying, transferring, loaning, copying, one-time-play, and transferring operations.

5. The method of claim 1 further comprising the step of analyzing a license to determine if the action requires internal or external authorization.

6. The method of claim 1 further comprising the step of analyzing a database to determine if the action requires internal or external authorization.

7. A method for digital-rights management, the method comprising the steps of:
determining a first action to be performed on digital content;
based on the first action, utilizing a first authorization scheme to allow the first action to be performed;
determining a second action to be performed on the digital content; and
based on the second action, utilizing a second authorization scheme to allow the second action to be performed, wherein the second authorization scheme differs from the first authorization scheme.

8. The method of claim 7 wherein the step of determining the first action comprises the step of determining an action taken from the group consisting of playing, counted-play, pay-per-view, printing, displaying, transferring, loaning, copying, one-time-play, and transferring operations.

9. The method of claim 8 wherein the step of determining the second action comprises the step of determining an action taken from the group consisting of playing, counted-play, pay-per-view, printing, displaying, transferring, loaning, copying, one-time-play, and transferring operations.

10. The method of claim 7 wherein the first authorization scheme comprises an external authorization scheme.

11. The method of claim 10 wherein the second authorization scheme comprises an internal authorization scheme.

12. The method of claim 7 further comprising the steps of:
analyzing a license to determine an authorization scheme required, wherein the license comprises action-based authorization schemes.

13. The method of claim 7 further comprising the steps of:
analyzing a database to determine an authorization scheme required, wherein the database comprises a list of actions requiring external or internal authorization.

14. A method comprising the steps of:
determining an action to be performed on a digital item;
determining if a token exists to perform the action; and
performing an internal authorization if a token exists, otherwise performing an external authorization.

15. The method of claim 14 wherein the step of determining the action comprises the step of determining an action taken from the group consisting of playing, counted-play, pay-per-view, printing, displaying, transferring, loaning, copying, one-time-play, and transferring operations.

16. A digital-rights management (DRM) license comprising:
an action; and
an enabling server that is based on the action.

17. The license of claim 16 wherein the action is taken from the group consisting of playing, counted-play, pay-per-view, printing, displaying, transferring, loaning, copying, one-time-play, and transferring operations.

18. The license of claim 16 further comprising:
a timeAllowedSinceLast parameter indicating a time allowed for a user to perform internal authorization.

19. The license of claim 16 further comprising:
a numberAllowedSinceLast parameter indicating a number of internal authorizations allowed.

20. A method comprising the steps of:
receiving a request from a device to perform an action on a digital item;
determining that the device is part of a group;
authorizing the action to be performed on the digital item;
updating internal state information to reflect that the action has been performed on the digital item; and
transmitting a message to all devices within the group instructing the devices to update internal state information to reflect that the action has been performed on the digital item.

21. An apparatus comprising:
a digital item;
a license to use the digital item;
and a digital-rights management (DRM) module, the DRM module determining an action to perform on the digital item and analyzes the license to determine a method for authorizing the digital item when a server is unavailable.
